(19) United States
(12) Patent Application Publication
(10) Pub. No.: US 2021/0033709 A1
(43) Pub. Date: Feb. 4, 2021

(54) MACROSCOPIC LIDAR DEVICE

(71) Applicant: Robert Bosch GmbH, Stuttgart (DE)

(72) Inventors: Annemarie Holleczek, Nuernberg (DE); Mustafa Kamil, Leonberg (DE)

(21) Appl. No.: 17/041,395

(22) PCT Filed: Mar. 20, 2019
(86) PCT No.: PCT/EP2019/056919

§ 371 Date: Sep. 24, 2020

(30) Foreign Application Priority Data
Mar. 28, 2018 (DE) 10 2018 204 708.1

(51) Int. Cl. G01S 7/481; G01S 17/931

(52) U.S. Cl. CPC G01S 7/4817; G01S 17/931; G01S 7/4811

(57) ABSTRACT

A LIDAR device that includes a stator element, and a rotor element that is situated on the stator element. The stator element includes a transmitting device and a receiving device. In the intended mounting position of the LIDAR device on a vehicle, during each half-rotation of the rotor element, a transmission beam of the transmitting device is essentially continuously emittable into a field of view directed toward the front, and a reception beam is essentially continuously receivable from the field of view directed toward the front.

### FIELD

The present invention relates to a macroscopic LIDAR device. Moreover, the present invention relates to a method for manufacturing a macroscopic LIDAR device.

### BACKGROUND INFORMATION

LIDAR macroscanners in which all optical elements as well as the laser and the detector are situated on a rotor and which include a rotating macromirror having a diameter in the centimeter range are conventional. As a result, in the transmission path a beam having a diameter in the centimeter range may be led across the rotating macromirror. With such systems in which all components “rotate,” it is advantageously possible that a horizontal field of view (FOV) of up to 360° may be scanned, inherent to the system.

At the same time, however, this represents a disadvantage in particular in an installation in a vehicle body (i.e., not on the vehicle roof), since measurement is not possible for up to two-thirds of the time, namely, when the laser on the rotor is pointing in the direction of the vehicle body. In addition, further disadvantages result for the system due to selecting a large vertical field of view; for example, systems with a fairly large field of view generally have a taller structure and are more costly.

German Patent No. DE 197 57 848 A1 describes a design of a rotatable laser scanner for use in vehicles, which scans a monitoring space using mirrors, it being also possible to provide multiple transmitting devices vertically relative to one another. It is provided that flat mirrors are situated and oriented in such a way that they swivel the beam in multiple planes with nonparallel scanning directions.

U.S. Pat. No. 7,295,298 B2 describes a design of a rotatable laser scanner in which a monitoring sector is enlarged, likewise using mirrors. A method is provided for scanning the vehicle surroundings with the aid of at least one optoelectronic device, the beams being deflected via a mirror in order to enlarge the field of view of the sensor.

U.S. Pat. No 5,808,728 describes a system for monitoring the vehicle surroundings via an optical radar device that emits and receives light, a rotatable mirror being mounted within the radar device.

### SUMMARY

An object of the present invention is to provide an improved scanning macroscopic LIDAR system.

According to a first aspect, the present invention provides a macroscopic LIDAR device. In accordance with an example embodiment of the present invention, the macroscopic LIDAR device includes:
a stator element; and
a rotor element that is situated on the stator element and that includes a transmitting device and a receiving device, in the intended mounting position of the LIDAR device on a vehicle, during each half-rotation of the rotor element a transmission beam of the transmitting device being essentially continuously emittable into a field of view directed toward the front, and a reception beam being essentially continuously receivable from the field of view directed toward the front.

It is thus advantageously possible to make better use of the rotating macroscopic LIDAR scanner, since even in the so-called “dark phase” of the LIDAR device, a field of view toward the front is illuminated. A doubling of the scanning power of the LIDAR device or an enlarged vertical field of view may thus be advantageously provided. The LIDAR device is thus advantageously very well suited for a concealed installation in the chassis of a vehicle. As a result, the provided LIDAR device has little or no dead time during scanning of the surroundings.

According to a second aspect, the object may be achieved with a method for manufacturing a macroscopic LIDAR device. In accordance with an example embodiment of the present invention, the method includes the steps:
providing a stator element; and
providing a rotor element that is situated on the stator element and that includes a transmitting device and a receiving device, the rotor element being designed in such a way that in the intended mounting position of the LIDAR device on a vehicle, during each half-rotation of the rotor element a beam of the transmitting device is essentially continuously emittable into a field of view directed toward the front, and a reception beam is essentially continuously receivable from the field of view directed toward the front.

Preferred specific embodiments of the LIDAR device in accordance with the present invention are described herein.

In one advantageous refinement of the LIDAR device in accordance with the present invention, with the aid of a deflection device, the transmission beam of the transmitting device and the reception beam are emittable into and receivable from the field of view directed toward the front during a phase in which the transmitting device is facing the vehicle. In this way, a meaningful increase in the performance of the LIDAR device may be achieved with little complexity, using a deflection device.

A further advantageous refinement of the LIDAR device in accordance with the present invention provides that the deflection device of the reception path and the transmission path includes two mirror elements that are situated at 90 degrees relative to one another and hemispherically mounted in an area of the LIDAR device facing the vehicle. The field of view of the LIDAR device during operation is thus directed essentially continuously toward the front, as the result of which a higher sampling rate for the LIDAR device may be achieved.

A further advantageous refinement of the LIDAR device in accordance with the present invention provides that the deflection device of the reception path and the transmission path includes two mirror elements that are situated at greater or less than 90 degrees relative to one another and hemispherically mounted in an area of the LIDAR device facing the vehicle. In this way, in the dark phase of the LIDAR device a field of view that is enlarged vertically, i.e., swiveled upwardly or downwardly with respect to the horizontal field of view, may be achieved.

A further advantageous refinement of the LIDAR device in accordance with the present invention provides that a separate deflection device is provided in each case for the reception path and the transmission path. This is achieved by situating lens elements of the reception path and of the transmission path one above the other. In this way, a biaxial system is advantageously provided in which the reception path and the transmission path are separate from one another.

A further advantageous refinement of the LIDAR device in accordance with the present invention provides that a shared deflection device is provided for the reception path and the transmission path. This is easily possible with the aid of lens elements at the rotor element which are spaced slightly apart from one another in a plane.

A further advantageous refinement of the LIDAR device in accordance with the present invention provides that the deflection device includes at least one of the following: mirror element, prism, axicon. Different elements may thus be advantageously used for implementing the deflection device.

A further advantageous refinement of the LIDAR device in accordance with the present invention provides that the deflection device is situated at the LIDAR device or at the vehicle. Different implementation options for the LIDAR device are advantageously provided; in the case of situating the deflection device at the LIDAR device, soiling problems on the deflection device are advantageously essentially avoided, and an optical configuration always remains essentially the same.

A further advantageous refinement of the LIDAR device in accordance with the present invention provides that it is designed to carry out a spatial laser beam expansion over an optical path along the deflection device within a dark phase. Due to the spatial distortion correction of the laser beam cross section by advantageous shaping of the deflection device (a curvature, for example), the optical power density decreases for the same beam power, resulting in advantages in eye safety. In the dark phase, the laser beam power of the LIDAR device may thus be increased in order to scan objects at a fairly large distance in front of the LIDAR device. Thus, for the LIDAR device two operating modes with regard to the range are advantageously achievable, in a light phase the LIDAR device having a smaller range, and in the dark phase the LIDAR device having a larger range. This may be attributed to different beam expansions of the laser beam due to different path lengths in the light phase and the dark phase.

The present invention is described in greater detail below with regard to further features and advantages, with reference to several figures. Identical or functionally equivalent elements have the same reference numerals. The figures are in particular intended to explain the main principles of the present invention, and are not necessarily illustrated true to scale. For better clarity, it may be provided that not all reference numerals are provided in all figures.

Provided device features analogously result from corresponding provided method features, and vice versa. This means in particular that features, technical advantages, and statements regarding the macroscopic LIDAR device analogously result from corresponding features, advantages, and statements regarding the method for manufacturing a macroscopic LIDAR device, and vice versa.

### BRIEF DESCRIPTION OF THE DRAWINGS

FIG. 1 shows a schematic illustration of a top view onto a conventional scanning macroscopic LIDAR device.

FIGS. 2a-2d show a schematic illustration with an explanation of the so-called light phase and dark phase of a scanning LIDAR device.

FIG. 3 shows an illustration of a light phase of a first specific embodiment of the scanning LIDAR device in accordance with the present invention.

FIG. 4 shows an illustration of a dark phase of one specific embodiment of the scanning LIDAR device in accordance with the present invention.

FIG. 5 shows an illustration of a light phase of a second specific embodiment of the scanning LIDAR device in accordance with the present invention.

FIG. 6 shows an illustration of a dark phase of the second specific embodiment of the provided scanning LIDAR device in accordance with the present invention.

FIG. 7 shows an illustration of a dark phase of the second specific embodiment of the provided scanning LIDAR device in accordance with the present invention.

FIG. 8 shows a schematic illustration of the sequence of one specific embodiment of a method for manufacturing a macroscopic LIDAR device in accordance with the present invention.

### DETAILED DESCRIPTION OF EXAMPLE EMBODIMENTS

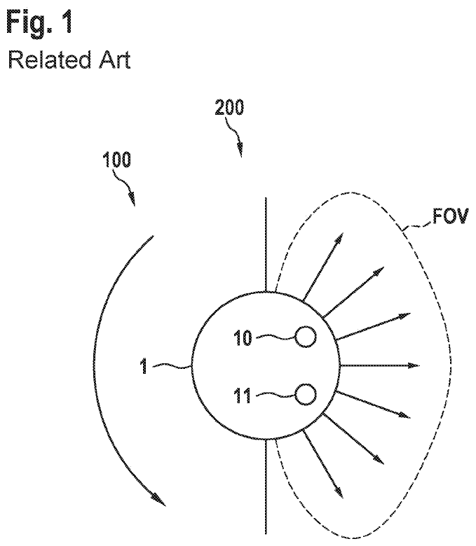

FIG. 1 shows a schematic top view onto a conventional LIDAR device 100. A rotor element 1 on which a first lens element 10 and a second lens element 11 are situated is apparent. A field of view FOV is indicated, which in an intended mounting position of LIDAR device 100 on a vehicle 200 points toward the front. Transmission beams of a laser are indicated by arrows. A built-in installation of LIDAR device 100 in vehicle 200 is therefore desirable, since LIDAR device 100 should be integrated into vehicle 200 in a preferably inconspicuous manner. However, due to a concealed installation site, a field of view FOV encompassing 360° is no longer usable. However, for the described system a reduction in field of view FOV is always accompanied by a reduction in the measuring time when the portion of rotor element 1 making the measurement is just outside field of view FOV.

The present invention provides a more efficiently operable macroscopic scanning LIDAR system.

This is achieved by designing LIDAR device 100 in such a way that during each half-rotation the field of view of LIDAR device 100 is continuously directed toward the front. This is achieved via technical means explained in greater detail below.

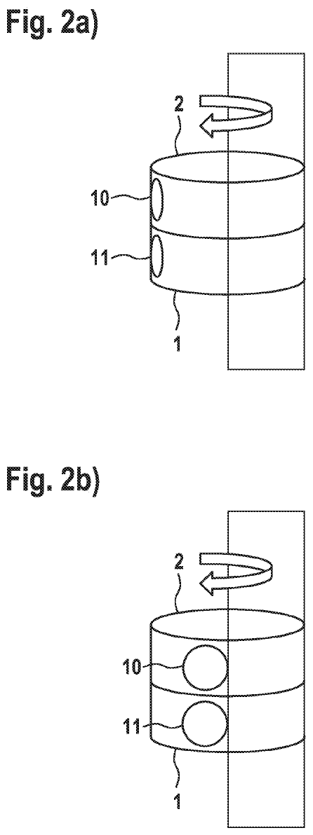

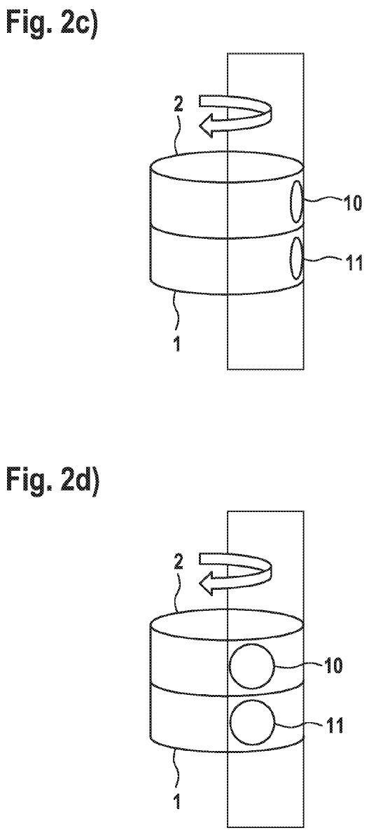

FIGS. 2d-2d show an explanation of the light phase and dark phase of a scanning LIDAR device. The light phase is characterized in that transmitting optics and receiving optics (designed as circular lens elements 10, 11) of a rotor element 2 of the scanning LIDAR device, situated on a stator element 1, may freely “look” into the vehicle surroundings in the travel direction. In the dark phase, the same elements 10, 11 “look” toward the vehicle body at the installation site on the vehicle, and therefore cannot “look” into the surroundings.

In FIG. 2a) it is apparent that shading by the body of the vehicle is not present, since the beam (not illustrated) is directed toward the front. In FIG. 2b) of the light phase, a transition into shading by the body of the vehicle takes place. In the dark phase which now begins, illustrated in FIG. 2c), shading of the transmission beam by the body is present due to the fact that the transmission beam is directed to the rear. Lastly, it is illustrated in FIG. 2d) that the shading by the body is still present, and following the rotation cycle of rotor element 2, the light phase begins once again with the conditions of FIG. 2a).

One specific example embodiment of a provided LIDAR device 100 requires use of deflection optics (deflection mirrors, for example), which are either an integral part of LIDAR device 100 or situated on the vehicle.

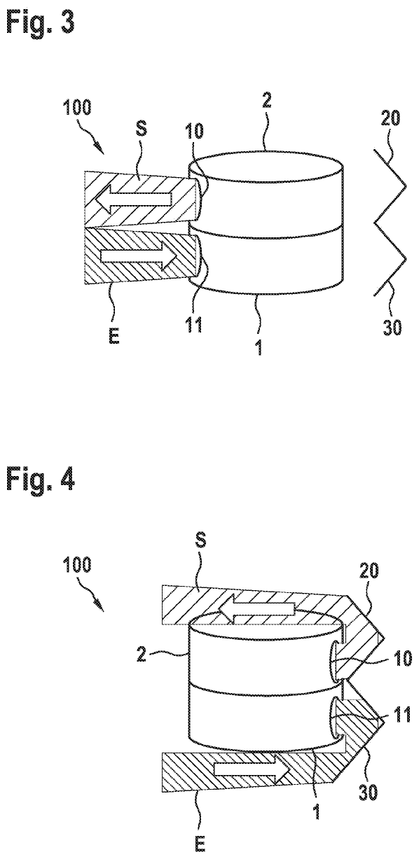

The optical effect thus achieved in the deflection of transmission beams and reception beams S, E in the light phase and dark phase is explained in greater detail with reference to FIGS. 3 and 4. FIG. 3 shows a regular operation of LIDAR device 100 in the light phase. In the dark phase, the deflected beams may be divergently diverted, in parallel with the plane of the beams in the light phase or away from same. This takes place depending on the setting of deflection device 20, 30. A first deflection device 20 is provided to deflect a transmission beam S in the dark phase, and to guide it across the LIDAR device, toward the front into the field of view. A second deflection device 30 is provided to guide a reception beam E, arriving below the LIDAR device, onto lens element 11 and into the interior of LIDAR device 100.

When deflection devices 20, 30 are rotatably or adjustably supported, a function that is variable during operation may be mapped, for example depending on the driving scenario (for example, urban automated driving requires recognition of a sidewalk border in the near field, and thus a very large field of view). The deflection devices or deflection optics are preferably designed as aluminum-coated mirror elements, for example, but may also be designed as passive prisms or axicons. Deflection devices 20, 30 must extend radially symmetrically about the rotational axis of the sensor so that they meet the desired deflection function over the entire dark phase.

FIG. 3 shows a first specific embodiment of provided macroscopic LIDAR device 100 in the light phase. It is apparent that transmission beam S is guided toward the front into the surroundings with the aid of a first lens element 10, reception beam E being received with the aid of a second lens element 11. Deflection devices 20, 30 are preferably designed as hemispherical mirrors that have a semicircular design in the rear area of LIDAR device 100. Deflection devices 20, 30 are preferably an integral part of LIDAR device 100, although it is also possible to situate deflection devices 20, 30 on the vehicle body.

As illustrated in FIG. 4, in a dark phase of LIDAR device 100 a deflection of transmission beam S onto first deflection device 20 is carried out, as the result of which transmission beam S is guided across LIDAR device 100, toward the front into the surroundings. Analogously, reception beam E is guided onto second deflection device 30 by second lens element 11 into the interior of LIDAR device 100.

Due to the fact that the mirrors of deflection devices 20, 30 are situated at a right angle relative to one another in an axis, transmission beam S and reception beam E are oriented in parallel to one another, as the result of which in the configuration of FIGS. 3 and 4, identical scanning characteristics of LIDAR device 100 toward the front into the field of view are achieved in the light phase as well as in the dark phase. As a result, a doubling of the sampling rate or frame rate of LIDAR device 100 may be achieved. This is advantageously possible with a cost-effective design of deflection devices 20, 30 as mirror elements.

As a result, in each half-rotation of rotor element 2, the beam of a transmitting device (not illustrated) of LIDAR device 100 is emitted toward the front. It is thus possible to advantageously achieve a higher frame rate using macroscopic LIDAR device 100, since the scanning beam is always directed toward the front.

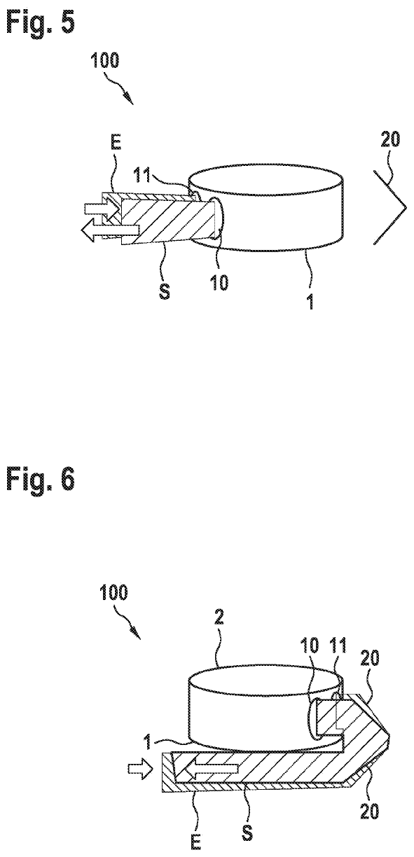

FIG. 5 shows a further specific embodiment of macroscopic LIDAR device 100. It is apparent that lens elements 10, 11 of the reception path and the transmission path are now situated in a plane and are laterally offset relative to one another at rotor element 2. In this variant, only a single deflection device 20 is necessary, which is preferably designed as mirror elements hemispherically mounted and provided at a right angle relative to one another. This allows transmission beam and reception beam S, E to have a mutually parallel design, as the result of which a field of view in front of LIDAR device 100 is illuminated which, except for a minimal lateral shift that is not relevant for the surroundings scanning by LIDAR device 100, is identical in both the light phase and in the dark phase. As a result, a higher refresh rate is possible in this case as well.

FIG. 6 shows LIDAR device 100 from FIG. 5 in the dark phase; transmission beam S, which is defined by lens element 10, strikes first deflection device 20 earlier than does reception beam E via lens element 11. For better clarity, the mirror elements of deflection device 20 for the transmission path are not illustrated at 90 degrees relative to one another; however, it is self-evident that the transmission path as well as the reception path utilize a single deflection device 20, whose mirror elements are situated at 90 degrees relative to one another.

As a result, only a single deflection device 20 is necessary, so that the structural shape of LIDAR device 100 may advantageously have a lower design than in the variant of FIGS. 3 and 4. As a result, for LIDAR device 100 in this case as well a biaxial concept is also implemented in which the reception path and the transmission path are designed to be separate from one another. One analogous specific embodiment with a coaxial arrangement of the transmission path and the reception path is likewise possible, to which the stated advantages may be transferred.

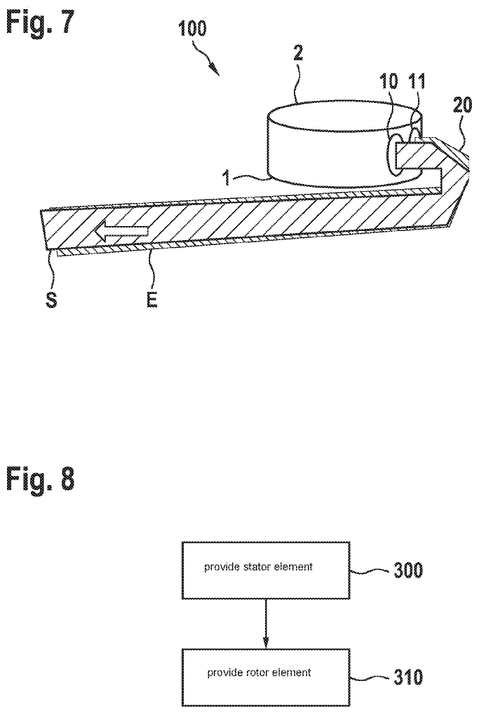

FIG. 7 shows a further specific embodiment of provided LIDAR device 100 in the dark phase. In this case, first deflection device 20 includes mirror elements situated at an angle greater than 90° relative to one another. As a result, in the light phase (not illustrated) a field of view is illuminated that is oriented essentially horizontally toward the front, in the dark phase a field of view, vertically swiveled with respect to the light phase, being illuminated due to the stated tilting of the mirror elements relative to one another. As a result, an enlarged vertical image field may be achieved for LIDAR device 100 with the aid of the signal processing.

Although this variant in FIG. 7 with lens elements 10, 11 is illustrated in a plane, it is self-evident that this concept is also possible for a variant of the LIDAR device with lens elements in planes situated one above the other (not illustrated).

In summary, with the present invention an optical macroscanner is provided in which a laser and a detector rotate on a platform; depending on the design, an increased frame rate or alternatively, an enlarged vertical image field, is achieved when the macroscanner is installed at an outer side of the vehicle body.

A second reception path and transmission path are advantageously added to the provided macroscanner, which allows the field of view to be scanned by two beam paths (instead of a single beam path, as in the related art). This advantageously results in there being no measurement dead time of the macroscopic LIDAR device, thus providing an increase in the frame rate of the sensor or an increase of the vertical image field.

This is advantageously possible with the aid of a cost-effective passive deflection device, for example in the form of aluminum-coated mirrors.

Although the vertical image field or alternatively, the frame rate, is doubled in this provided concept, the number of elements advantageously does not double, thus allowing a cost-effective implementation of the provided LIDAR device. As a result, the installation size of the LIDAR device is essentially maintained or its installation height is only slightly increased. The system may remain technologically unchanged by use of the deflection device. The emitted laser power may be passively switched between the front side and the rear side of the sensor in an instantaneous, loss-free manner.

In one advantageous specific embodiment, the provided LIDAR device, in addition to the above-described biaxial variants, may also be designed as a coaxial system (with an identical reception path and transmission path).

With the above-described variants of provided LIDAR device 100, it is advantageously possible to utilize the total rotation time of the rotor of LIDAR device 100 as active measuring time.

FIG. 8 shows a schematic sequence of one specific embodiment of the provided method for manufacturing a LIDAR device 100.

A stator element 1 is provided in a step 300.

Provision of a rotor element 2, which includes a transmitting device and a receiving device, on stator element 1 is carried out in a step 310, rotor element 2 being designed in such a way that in the intended mounting position of LIDAR device 100 on a vehicle, during each half-rotation of rotor element 2 a beam of the transmitting device is essentially continuously emittable into a field of view FOV directed toward the front, and a reception beam E is essentially continuously receivable from field of view FOV directed toward the front.

The order of steps 300 and 310 is advantageously arbitrary.

It is apparent to those skilled in the art that numerous modifications of the present invention are possible without departing from the core of the present invention.

1-10. (canceled)

11. A LIDAR device, comprising:
a stator element; and
a rotor element that is situated on the stator element and that includes a transmitting device and a receiving device, wherein, in an intended mounting position of the LIDAR device on a vehicle, during each half-rotation of the rotor element, a transmission beam of the transmitting device is continuously emittable into a field of view directed toward in front of the LIDAR device, and a reception beam is continuously receivable from the field of view directed toward the front.

12. The LIDAR device as recited in claim 11, further comprising:
a deflection device using which the transmission beam of the transmitting device and the reception beam are emittable into and receivable from the field of view directed toward the front during a phase in which the transmitting device is facing the vehicle.

13. The LIDAR device as recited in claim 12, wherein the deflection device is in a reception path of the reception beam and a transmission path of the transmission beam, and includes two mirror elements that are situated at 90 degrees relative to one another and hemispherically mounted in an area of the LIDAR device facing the vehicle.

14. The LIDAR device as recited in claim 12, wherein the deflection device is in a reception path of the reception beam and a transmission path of the transmission beam, and includes two mirror elements that are situated at greater or less than 90 degrees relative to one another and are hemispherically mounted in an area of the LIDAR device facing the vehicle.

15. The LIDAR device as recited in claim 14, wherein a separate deflection device is provided for the reception path and for the transmission path.

16. The LIDAR device as recited in claim 14, wherein a shared deflection device is provided for the reception path and the transmission path.

17. The LIDAR device as recited in claim 12, wherein the deflection device includes at least one of the following: mirror element, prism, axicon.

18. The LIDAR device as recited in claim 12, wherein the deflection device is situated at the LIDAR device or at the vehicle.

19. The LIDAR device as recited in claim 12, wherein the LIDAR device is designed to carry out a spatial laser beam expansion over an optical path along the deflection device within a dark phase.

20. A method for manufacturing a macroscopic LIDAR device, comprising the following steps:
providing a stator element; and
providing a rotor element situated on the stator element, the rotor element including a transmitting device and a receiving device, the rotor element being configured in such a way that in an intended mounting position of the LIDAR device on a vehicle, during each half-rotation of the rotor element, a beam of the transmitting device is continuously emittable into a field of view directed toward in front of the LIDAR device, and a reception beam is continuously receivable from the field of view directed toward the front.
